(19) United States
(12) Patent Application Publication
(10) Pub. No.: US 2024/0302530 A1
(43) Pub. Date: Sep. 12, 2024

(54) LIDAR MEMORY BASED SEGMENTATION

(71) Applicant: Waabi Innovation Inc., Toronto (CA)

(72) Inventors: Enxu LI, Toronto (CA); Sergio CASAS ROMERO, Toronto (CA); Raquel URTASUN, Toronto (CA)

(73) Assignee: Waabi Innovation Inc., Toronto (CA)

(21) Appl. No.: 18/598,958

(22) Filed: Mar. 7, 2024

Related U.S. Application Data
(60) Provisional application No. 63/450,629, filed on Mar. 7, 2023.

(51) Int. Cl. G01S 17/894; G01S 7/4865; G01S 17/931; G06T 7/11

(52) U.S. Cl. CPC G01S 17/894; G01S 7/4865; G01S 17/931; G06T 7/11; G06T 2207/10028; G06T 2207/20084; G06T 2207/30252

(57) ABSTRACT

LiDAR based memory segmentation includes obtaining a LiDAR point cloud that includes LiDAR points from a LiDAR sensor, voxelizing the LiDAR points to obtain LiDAR voxels, and encoding the LiDAR voxels to obtain encoded voxels. A LiDAR voxel memory is revised using the encoded voxels to obtain revised LiDAR voxel memory, decoding the revised LiDAR voxel memory to obtain decoded LiDAR voxel memory features. The LiDAR points are segmented using the decoded LiDAR voxel memory features to generate a segmented LiDAR point cloud.

### CROSS-REFERENCE TO RELATED APPLICATIONS

This application is a non-provisional application of, and thereby claims benefit to U.S. Patent Application Ser. No. 63/450,629 filed on Mar. 7, 2023, which is incorporated herein by reference in its entirety.

### BACKGROUND

LiDAR, which stands for Light Detection and Ranging, is a remote sensing method that uses light in the form of a pulsed laser to measure ranges (variable distances) to various objects. LiDAR can provide accurate geometric measurements of the three-dimensional (3D) world.

LiDAR sensors use time-of-flight to obtain measurements of a surrounding region. Specifically, a LiDAR sensor may scan the environment by rotating emitter-detector pairs (e.g., beams) around the azimuth. At every time step, each emitter emits a light pulse which travels until the beam hits a target, gets reflected, and is received by the detector. Distance is measured by calculating the time of travel. The result of a beam is a LiDAR point in a LiDAR point cloud. Through multiple such beams, the full LiDAR point cloud is generated.

LiDAR is used in semi-autonomous and fully autonomous systems. For example, to effectively perceive an autonomous system's surroundings, autonomous systems may exploit LiDAR as the major sensing modality since the autonomous system can capture well the 3D geometry of the world.

Unfortunately, dense LiDAR sensors are expensive, and the point clouds captured by low-beam LiDAR are often sparse. Thus, accurate detection of identification objects can be a challenge.

### SUMMARY

In general, in one aspect, one or more embodiments relate to a method that includes obtaining a LiDAR point cloud that includes LiDAR points from a LiDAR sensor, voxelizing the LiDAR points to obtain LiDAR voxels, and encoding the LiDAR voxels to obtain encoded voxels. The method further includes revising a LiDAR voxel memory using the encoded voxels to obtain revised LiDAR voxel memory, decoding the revised LiDAR voxel memory to obtain decoded LiDAR voxel memory features. The LiDAR points are segmented using the decoded LiDAR voxel memory features to generate a segmented LiDAR point cloud.

In general, in one aspect, one or more embodiments relate to a system that includes one or more computer processors and a non-transitory computer readable medium comprising computer readable program code for causing the one or more computer processors to perform operations. The operations include obtaining a LiDAR point cloud that includes LiDAR points from a LiDAR sensor, voxelizing the LiDAR points to obtain LiDAR voxels, and encoding the LiDAR voxels to obtain encoded voxels. The operations further include revising a LiDAR voxel memory using the encoded voxels to obtain revised LiDAR voxel memory, decoding the revised LiDAR voxel memory to obtain decoded LiDAR voxel memory features. The LiDAR points are segmented using the decoded LiDAR voxel memory features to generate a segmented LiDAR point cloud.

In general, in one aspect, one or more embodiments relate to a non-transitory computer readable medium comprising computer readable program code for causing a computer system to perform operations. The operations include obtaining a LiDAR point cloud that includes LiDAR points from a LiDAR sensor, voxelizing the LiDAR points to obtain LiDAR voxels, and encoding the LiDAR voxels to obtain encoded voxels. The operations further include revising a LiDAR voxel memory using the encoded voxels to obtain revised LiDAR voxel memory, decoding the revised LiDAR voxel memory to obtain decoded LiDAR voxel memory features. The LiDAR points are segmented using the decoded LiDAR voxel memory features to generate a segmented LiDAR point cloud.

Other aspects of the invention will be apparent from the following description and the appended claims.

### BRIEF DESCRIPTION OF DRAWINGS

FIG. 1 shows an autonomous system with a virtual driver in accordance with one or more embodiments.

FIG. 2 shows a point segmentation system in accordance with one or more embodiments of the invention.

FIG. 3 shows a diagram of an example of a voxelization process in accordance with one or more embodiments of the invention.

FIG. 4 shows a flowchart for LiDAR memory-based segmentation in accordance with one or more embodiments of the invention.

FIG. 5 shows a flowchart for revising the LiDAR voxel memory in accordance with one or more embodiments of the invention.

FIG. 6 shows an example of a point segmentation system in accordance with one or more embodiments of the invention.

FIG. 7 shows an example of a memory revision process in accordance with one or more embodiments.

FIG. 8 shows an example of LiDAR voxel memory over time in accordance with one or more embodiments.

FIGS. 9.1 and 9.2 show a computing system in accordance with one or more embodiments of the invention.

Like elements in the various figures are denoted by like reference numerals for consistency.

### DETAILED DESCRIPTION

Embodiments are directed to a segmentation of LiDAR point clouds using historical LiDAR voxel data captured in LiDAR voxel memory. Segmentation is a process of identifying portions of an image that have objects and identifying the types of objects shown in each portion of the image. In a LiDAR point cloud, the image is the three-dimensional LiDAR point cloud having LiDAR points. A LiDAR point is acquired by transmitting a beam of light, which reflects off of an object back to a LiDAR sensor. The segmentation classifies each of the LiDAR points in the LiDAR point cloud as to the type of object that reflected the corresponding beam. Thus, segmentation is a prediction of the types and locations of objects in the LiDAR point cloud. Because LiDAR point clouds may be sparse, the segmentation of the LiDAR point cloud from a single capture may be inaccurate.

To improve the accuracy of segmenting the current LiDAR point cloud, one or more embodiments use the historical LiDAR voxel data that is in the LiDAR voxel memory. The LiDAR points of the current LiDAR point cloud are voxelized and encoded. The encoded voxels are used to revise the LiDAR voxel memory. Specifically, individual voxels in memory are updated based on the revision. Thus, as more and more data is received, the LiDAR voxel memory has a more accurate representation of the surrounding area. The revised LiDAR voxel memory may then be used in conjunction with the LiDAR points in the current LiDAR point cloud to segment the current LiDAR point cloud.

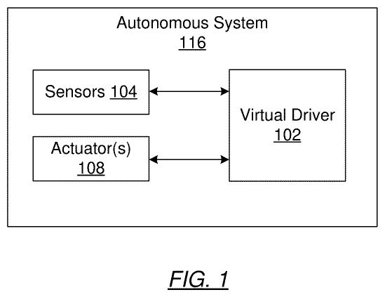

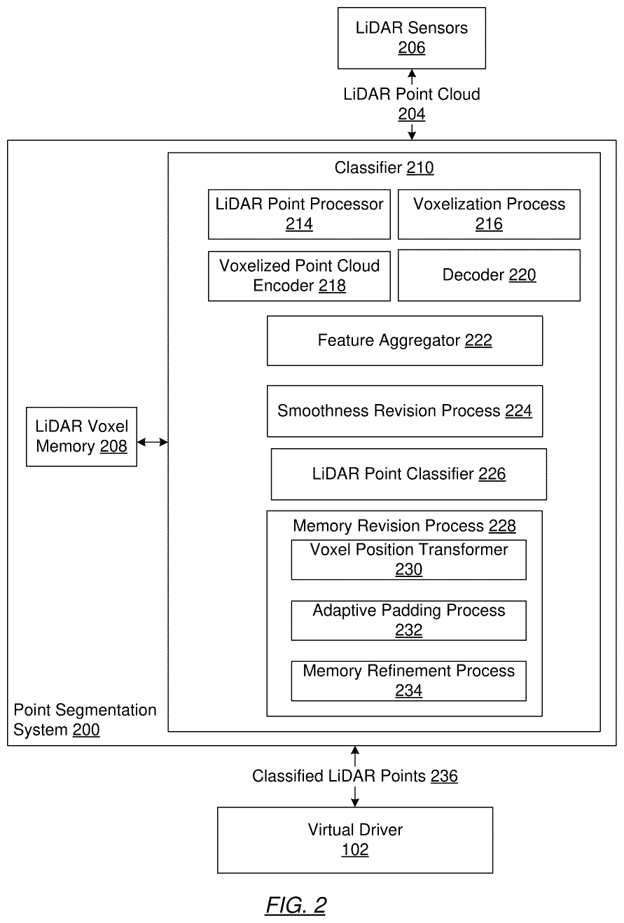

One or more embodiments may be used by an autonomous system that uses LiDAR to detect objects. Turning to the Figures, FIGS. 1 and 2 show example diagrams of the autonomous system and virtual driver. Turning to FIG. 1, an autonomous system (116) is a self-driving mode of transportation that does not require, but may use, a human pilot or human driver to move and react to the real-world environment. The autonomous system (116) may be completely autonomous or semi-autonomous. As a mode of transportation, the autonomous system (116) is contained in a housing configured to move through a real-world environment. Examples of autonomous systems include self-driving vehicles (e.g., self-driving trucks and cars), drones, airplanes, robots, etc.

The autonomous system (116) includes a virtual driver (102) which is the decision-making portion of the autonomous system (116). The virtual driver (102) is an artificial intelligence system that learns how to interact in the real world and interacts accordingly. The virtual driver (102) is the software executing on a processor that makes decisions and causes the autonomous system (116) to interact with the real-world including moving, signaling, and stopping or maintaining a current state. Specifically, the virtual driver (102) is decision making software that executes on hardware (not shown). The hardware may include a hardware processor, memory, or other storage device, and one or more interfaces. A hardware processor is any hardware processing unit that is configured to process computer readable program code and perform the operations set forth in the computer readable program code.

A real-world environment is the portion of the real world through which the autonomous system (116), when trained, is designed to move. Thus, the real-world environment may include concrete and land, construction, and other objects in a geographic region along with agents. The agents are the other objects in the real-world environment that are capable of moving through the real-world environment. Agents may have independent decision-making functionality. The independent decision-making functionality of the agent may dictate how the agent moves through the environment and may be based on visual or tactile cues from the real-world environment. For example, agents may include other autonomous and non-autonomous transportation systems (e.g., other vehicles, bicyclists, robots), pedestrians, animals, etc.

In the real world, the geographic region is an actual region within the real-world that surrounds the autonomous system. Namely, from the perspective of the virtual driver, the geographic region is the region through which the autonomous system moves.

The real-world environment changes as the autonomous system (116) moves through the real-world environment. For example, the geographic region may change, and the agents may move positions, including new agents being added and existing agents leaving.

In order to interact with the real-world environment, the autonomous system (116) includes various types of sensors (104), such as LiDAR sensors amongst other types, which are used to obtain measurements of the real-world environment, and cameras that capture images from the real-world environment. LiDAR (i.e., the acronym for “light detection and ranging”) is a sensing technique that uses light in the form of a pulsed laser to measure ranges (variable distances) to various objects in an environment. The autonomous system (116) may include other types of sensors as well. The sensors (104) provide input to the virtual driver (102).

In addition to sensors (104), the autonomous system (116) includes one or more actuators (108). An actuator is hardware and/or software that is configured to control one or more physical parts of the autonomous system based on a control signal from the virtual driver (102). In one or more embodiments, the control signal specifies an action for the autonomous system (e.g., turn on the blinker, apply breaks by a defined amount, apply accelerator by a defined amount, turn the steering wheel or tires by a defined amount, etc.). The actuator(s) (108) are configured to implement the action. In one or more embodiments, the control signal may specify a new state of the autonomous system and the actuator may be configured to implement the new state to cause the autonomous system to be in the new state. For example, the control signal may specify that the autonomous system should turn by a certain amount while accelerating at a predefined rate, while the actuator determines and causes the wheel movements and the amount of acceleration on the accelerator to achieve a certain amount of turn and acceleration rate.

Although not shown in FIG. 1, embodiments may be used in a virtual environment, such as when the virtual driver is being trained and/or tested in a simulated environment created by a simulator. In such a scenario, to the virtual driver, the simulated environment appears as the real-world environment.

In one or more embodiments, the virtual driver of the autonomous system or another component may include a point segmentation system. However, the point segmentation system may be used outside of the technological environment of the autonomous system. For example, the point segmentation system may be used in conjunction with virtually any system that uses LiDAR data.

FIG. 2 shows a schematic diagram of a system that includes LiDAR sensors (206), a point segmentation system (200), and a virtual driver. The LiDAR sensors (206) are virtual or real LiDAR sensors. Each LiDAR sensor (206) may be configured to emit pulsed light waves into the surrounding environment. The pulse light waves reflect off surrounding objects and return to the sensor. The sensor uses the time difference between the sending of the pulse light wave and the receiving of the pulse light wave by the LiDAR sensor to calculate the distance that the pulse light wave traveled. The LiDAR sensor may also record the direction and the intensity of the returned light wave. The LiDAR sensors (206) are configured to provide LiDAR point clouds (204) to the point segmentation system (200). For example, the LiDAR sensors (206) may be the real LiDAR sensors as described above with reference to FIG. 1, or a virtualized version thereof. In the virtualized case, a software system may be configured to recreate a LiDAR point cloud in accordance with a specified density. The system may include a set of LiDAR sensors that includes multiple LiDAR sensors or a single LiDAR sensor.

LiDAR point cloud (204) is a collection of LiDAR points. In one or more embodiments, the LiDAR point cloud may be a single scan of a surrounding region that surrounds the LiDAR sensor. In other embodiments, the LiDAR point cloud may be a frame having multiple scans of the sensing region. The LiDAR point cloud captures the state of the surrounding region at a particular point in time. For example, the LiDAR point cloud may result from a Lidar sweep, such as a LiDAR sweep that is performed every hundred milliseconds.

The LiDAR point cloud (204), when received, may be received as a list of LiDAR points. The LiDAR points may each have a distance, direction, and intensity. The distance and direction may be with respect to the LiDAR sensor. The LiDAR points may be translated into three-dimensional (3D) space. For example, each point in the list may be translated to being in the three-dimensional cartesian coordinate system with a value specifying an intensity.

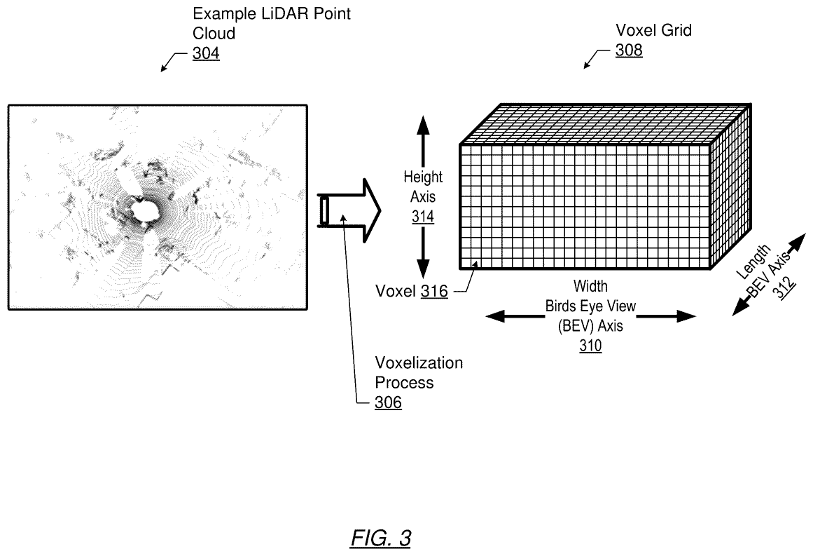

Turning briefly to FIG. 3, FIG. 3 shows an example of a LiDAR point cloud (4). In one or more embodiments, LiDAR points in the LiDAR point cloud are defined in the cartesian coordinate system (e.g., with x, y, and z axes) that is a scaled model of the 3D geographic region.

A voxelization process (306) may be performed on the LiDAR point cloud to generate a voxel grid (308) for LiDAR. As with the example LiDAR point cloud (304), the voxel grid (308) is three dimensional (3D). The voxel grid (308) is a grid having three axes in one or more embodiments. The first two axes are a width birds eye view (BEV) axis (310) and a length BEV axis (312). The width BEV axis (310) and the length BEV axis (312) are axes that are parallel to the ground or to the zero-elevation plane. The third axis is perpendicular to the width and length axis. The third axis is a height axis (314) that corresponds to elevation from the Earth. For example, the width and length axis may be substantively planar to the longitudinal and latitudinal axes while the third axis is parallel to the height axis and corresponds to elevation.

The voxel grid (308) is partitioned into voxels, whereby a one-to-one mapping exists between voxels in the grid and subregions of the geographic region. A voxel is a distinct 3D block in the 3D grid that is adjacent to other voxels. The location of the voxel with respect to the 3D grid defines the corresponding subregion in the geographic region to which the voxel refers. Accordingly, locations in the geographic region are deemed to be mapped to a particular voxel of the 3D LiDAR image when the location is in a subregion that is mapped to or referenced by the voxel.

The size of each subregion mapped to each voxel is dependent on and defined by the resolution of the 3D voxel grid (308). In one or more embodiments, the resolution of the 3D voxel grid (308) is configurable. Further, multiple LiDAR points may be mapped to the same voxel of the 3D voxel grid (308).

The voxelization process (306) may identify, for each LiDAR point, the voxel mapped to the subregion of the geographic region that includes the location identified by the LiDAR point. Namely, as the 3D point cloud points are defined for specific locations in the geographic region and the voxel grid is for the same geographic region, superimposing the 3D point cloud onto the voxel grid results in, for at least one voxel, one or more LiDAR points being within a corresponding voxel. The voxelization process (306) may also determine an offset of the LiDAR point with respect to a centroid of the voxel (e.g., voxel (316)). In one or more embodiments, the voxelization process (306) also determines a value for the voxel as a whole based on features extracted from the LiDAR points that are mapped to the voxel.

The type of data structure that is the voxel grid (308) may vary. For example, the voxel grid (308) is a sparse grid because many locations do not have objects. Thus, not all voxels in the voxel grid need to be stored.

For explanatory purposes, a voxel grid created from a current LiDAR point cloud may be referred to as a current voxel grid. Namely, the current voxel grid is generated from the LiDAR point cloud for which the segmentation process is currently being performed.

Returning to FIG. 2, the LiDAR sensors (206) are connected to the point segmentation system (200). The point segmentation system (200) is a software system that is configured to segment a LiDAR point cloud (204) using a LiDAR voxel memory (208). The point segmentation system (200) is configured to generate and revise LiDAR voxel memory (208). The point segmentation system (200) includes LiDAR voxel memory (208) and a classifier (210). Each of these components is described below.

The LiDAR voxel memory (208) is storage that stores voxel data for a geographic region. In one or more embodiments, the LiDAR voxel memory is a data structure. The data structure may have a single set of values for each voxel, whereby a single voxel exists for each sub-region of the geographic region. The single set of values are for the voxel as a whole rather than individual locations within a voxel in accordance with one or more embodiments. Voxels in the LiDAR voxel memory are referred to as memory voxels. In one or more embodiments, the LiDAR voxel memory (208) is a voxel grid (as described in reference to voxel grid (308) of FIG. 3). Specifically, each memory voxel has a corresponding subregion of a geographic region, and the geographic region has a single corresponding voxel. Thus, the set of values for the memory voxel is for the subregion corresponding to the memory voxel. In one or more embodiments, the set of values is a single data encoding for the memory voxel.

Because the LiDAR voxel memory (208) maintains data at the granularity level of the voxel, and not all subregions have objects, the LiDAR voxel memory (208) may be a sparse data structure. By having a sparse data structure, the LiDAR voxel memory (208) is smaller allowing for the geographic region to be bigger and for not explicitly removing data from the LiDAR voxel memory. For example, as new LiDAR points are received, the new LiDAR points through the machine learning may be given greater weight than previously stored data for the memory voxel when revising an encoding, but the previously stored data for the memory voxel is necessarily removed such as would be done by a sliding window.

The LiDAR voxel memory is connected to a classifier (210). The classifier (210) is configured to classify LiDAR points using the LiDAR voxel memory (208) and generate classified LiDAR points (236). The classifier (210) includes functionality to output the classified LiDAR points (236) to a virtual driver (102). The classifier (210) includes a LiDAR point processor (214), a voxelization process (216), a voxelized point cloud encoder (218), a decoder (220), a feature aggregator (222), a smoothness revision process (224), a LiDAR point classifier (226), and a memory revision process (228). Each of these components is described below.

The LiDAR point processor (214) is a machine learning framework that operates on the LiDAR point level of granularity. The LIDAR point processor (214) is configured to generate and encode features for individual LiDAR points from the LiDAR point cloud. The machine learning framework may include multiple neural networks. By way of an example, the LiDAR point processor may be a set of multilayer perceptron models.

The voxelization process (216) is configured to voxelize a LiDAR point cloud as described in reference to FIG. 3. Specifically, the voxelization process determines, for each LiDAR point, the memory voxel having the LiDAR point. The voxelization process may further include functionality to determine the 3D offset of the LiDAR point from the voxel center. Further, in one or more embodiments, the voxelization process may be configured to aggregate features for the LiDAR points in a voxel to generate a feature set for the memory voxel.

The voxelized point cloud encoder (218) is a machine learning model or a set of machine learning models that is configured to generate an encoding from the features of the current voxel grid. In one or more embodiments, the voxelized point cloud encoder (218) is a convolutional neural network (CNN). Because relatively few locations in a geographic region are occupied by a surface of objects, the CNN may be a sparse CNN. The CNN is configured to generate a feature map from the feature vectors of the current voxel grid.

The decoder (220) is a set of neural network layers that is configured to decode the LiDAR voxel memory. The decoder may include convolutional layers. The decoder (220) may be executed after the revision process for the current LiDAR point cloud (204).

The feature aggregator (222) is a software process that is configured to aggregate the point level features extracted from the LiDAR point cloud with the voxel level features. In one or more embodiments, the feature aggregator is configured to concatenate, on a per LiDAR point basis, LiDAR point level features with voxel level features of the voxel that has the corresponding LiDAR point.

The LiDAR point classifier (226) is a classifier model. The LiDAR point classifier (226) is configured to predict an object type for each LiDAR point. In one or more embodiments, the object type is the type of physical object that the light wave reflected off of before being received by the LiDAR sensor resulting in the LiDAR point. For example, the type of object may be a vehicle, person, plane, ball, bicyclist, building, truck, or other type of object. The LiDAR point classifier (226) may have a defined set of classes, each class being for a particular type of object. In one or more embodiments, the LiDAR point classifier (226) outputs a probability for each of at least a subset of classes for each LiDAR point in the current LiDAR point cloud.

The smoothness revision process (224) is a software process that may revise the classification of the LiDAR points based on neighboring LiDAR points. For example, LiDAR points at an edge of an object should have a different class than neighboring LiDAR points. Conversely, LiDAR points that are not at the edge of an object should have at least approximately a same class prediction. Thus, the smoothness revision process (224) considers the classification of neighboring LiDAR pixels to update the class of the current LiDAR pixel.

The memory revision process (228) is a set of processes that is configured to revise the LiDAR voxel memory (208). Revising the LiDAR voxel memory modifies individual values of the memory voxels that are in the LiDAR voxel memory. Revising may further add memory voxels based on subregions being added to the geographic region or objects being in subregions that previously did not have objects.

The memory revision process (228) includes a voxel position transformer (230), an adaptive padding process (232), and a memory refinement process (234). The voxel position transformer (230) is a software process that transforms voxels in the LiDAR voxel memory based on the new position of the LiDAR sensor. For example, as the autonomous system is moving through the geographic region, the location of the LiDAR sensor changes. Thus, the perspective of the LiDAR sensor when capturing the current LiDAR point cloud is different than the perspectives of the LiDAR sensor when capturing the LiDAR point clouds reflected in LiDAR voxel memory. To accommodate the change, the memory voxels in LiDAR voxel memory is updated based on the change in perspective. The update is a translation of the memory voxels.

The adaptive padding process (232) is a software process that is configured to cause the current voxel grid to have the same density as the LiDAR voxel memory. The density is the number of voxels that have values. The adaptive padding process (232) is configured to pad the current voxel grid with memory voxels that have values in LiDAR voxel memory. The adaptive padding process (232) is further configured to pad the LiDAR voxel memory with voxels that have values in the current voxel grid. Padding adds missing values to the current voxel grid or the LiDAR voxel memory. The adaptive padding process (232) may update the encoding by matching added voxels to neighboring voxels and updating the encoding based on the neighboring voxels.

The memory refinement process (234) is a software process that is configured to refine the LiDAR voxel memory (208). The memory refinement process (234) refines the LiDAR voxel memory (208) with the current voxel grid to place more emphasis on the current voxel grid. The refinement process refines voxels that are already in the LiDAR voxel memory prior to the current voxel grid and based on the current voxel grid. The refinement process may further refine new voxels.

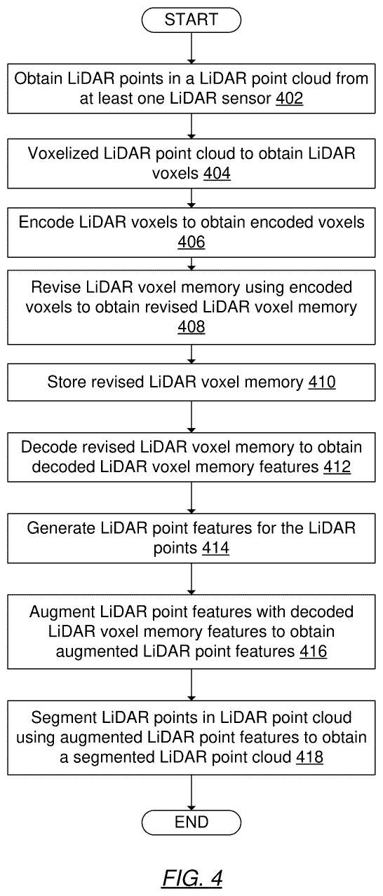

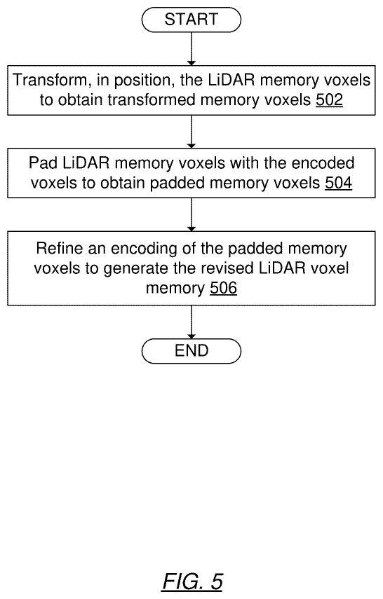

FIG. 4 shows a flowchart for LiDAR point cloud segmentation in accordance with one or more embodiments. FIG. 5 shows a flowchart for a memory refinement process in accordance with one or more embodiments. While the various steps in these flowcharts are presented and described sequentially, at least some of the steps may be executed in different orders, may be combined, or omitted, and at least some of the steps may be executed in parallel. Furthermore, the steps may be performed actively or passively.

Turning to FIG. 4, the LiDAR point cloud segmentation of FIG. 4 may be performed with each scan of a surrounding region. In Block 402, LiDAR points in a LiDAR point cloud are obtained from at least one LiDAR sensor. In the autonomous system, one or more LiDAR sweeps may be performed by one or more real LiDAR sensors. As another example, LiDAR sweeps may be performed by one or more LiDAR sensors that are part of a different system. To perform a LiDAR sweep, the light pulse is transmitted by the LiDAR transmitter of the LiDAR sensor. The light pulse may reflect off of an object, albeit unknown, in the environment, and the time and intensity for the reflected light pulse to return to the receiver is determined. The time is used to determine the distance to an object. The result is a LiDAR point in the LiDAR data. For the LiDAR sweep, multiple light pulses are transmitted at a variety of angles, and multiple reflected lights are received to obtain multiple points in the LiDAR point cloud. The LiDAR point cloud may be obtained as a list of LiDAR points. The list may be translated to a LiDAR point cloud. One or more sensing frames may be combined into a LiDAR point cloud, whereby a sensing frame is a scan of the geographic region.

Rather than using a real LiDAR sensor, the simulator, using a sensor simulation model for the LiDAR sensor, may generate simulated LiDAR input data. Specifically, the simulator may generate a scene and render the scene. Machine learning models that are part of the simulator may determine the intensity of the LiDAR points to the various objects in the scene based on the location of the virtual LiDAR sensor in the scene. The relative positions of the virtual LiDAR sensor to the locations of the objects are used to determine the respective distance. The result is a simulated set of LiDAR points that mimic real LiDAR data for a particular simulated scene. The simulated LiDAR data may be of virtually any resolution. For example, the simulated LiDAR data may match the resolution of a real LiDAR sensor.

In Block 404, the LiDAR point cloud is voxelized to obtain LiDAR voxels in a current voxel grid. Each LiDAR point has a location in a cartesian coordinate system and an intensity. In some embodiments, the LiDAR points may be processed through a first set of neural network layers to generate a first set of LiDAR point features. For example, for each LiDAR point, the value of the location in the three coordinates may be concatenated together with the intensity. The result is an input feature set to the first set of neural network layers that generates an output feature set for each LiDAR point. The output feature set may be on a point level basis. For example, each LiDAR point may be associated with the first set of point features and the original location (e.g., in the cartesian coordinate system).

Each LiDAR point may be individually voxelized through the voxelization process of FIG. 3. During the voxelization process, the location in the geographic region of the LiDAR point is matched to the subregion of the geographic region that contains the location. Further, an offset in the 3D space from the centroid of the voxel is identified. For the voxels in the current voxel grid, each voxel may be associated with multiple sets of features. The sets of features may be aggregated. For example, the aggregation may be to perform an averaging. Further, in one or more embodiments, the LIDAR points may each be associated with the location, the offset from the centroid, and the first set of features. The location, offset, and first set of features may be concatenated together. The current voxel grid and the LiDAR points may be processed through distinct pipelines.

In Block 406, the LiDAR voxels are encoded to obtain encoded voxels. In one or more embodiments, the current voxel grid is processed through a sparse CNN. The current voxel grid when processed has the three dimensions of the locations and the fourth dimension of the feature set for the voxel. The CNN updates the features of the voxels to account for the features of the surrounding voxels. Thus, the encoding updates the features of each voxel. In one or more embodiments, the size of the current voxel grid does not change when encoding the LiDAR voxels. Each voxel after the encoding is associated with a corresponding subregion of the geographic region.

In Block 408, the LiDAR voxel memory is revised using encoded voxels to obtain revised LiDAR voxel memory. In one or more embodiments, the values of individual voxels in the LiDAR voxel memory are updated based on the current voxel grid. Notably, both the autonomous system and other objects in the geographic region may move between LiDAR sweeps. Thus, the revision accounts for the movement of objects. To account for the movement of the autonomous system, the voxels in the geographic region are transformed in position based on the amount of movement. New voxels may be added to the LiDAR voxel memory using the current voxel grid as the geographic region of the autonomous system changes. To account for the movement of other objects, when the padding is performed, the features of neighboring voxels are considered. Further, a greater weight is given to the current voxel grid when updating the voxel features. Revising the LiDAR voxel memory is described in reference to FIG. 5.

Continuing with FIG. 4, in Block 410, the revised LiDAR voxel memory is stored. The revised LiDAR voxel memory may be stored in physical memory for the next LiDAR point cloud that is obtained. Thus, by using historical data, the system continually obtains a more accurate segmentation of the surrounding region.

In Block 412, the revised LiDAR voxel memory is decoded to obtain decoded LiDAR voxel memory features. In one or more embodiments, the revised LiDAR voxel memory is processed through convolutional layers to generate a set of features for each voxel that is ready for segmentation.

In Block 414, LiDAR point features are generated for the LiDAR points. As described in reference to Block 404, the current voxel grid is processed through a first pipeline and the LiDAR points are processed through a second pipeline. In the second pipeline, the LiDAR points are processed by a second set of neural network layers.

For example, the location of the LiDAR point, the offset from the center, and the features may be concatenated together. The concatenation may be processed through the second set of neural network layers to generate a second set of LiDAR point features for each LiDAR point. The LiDAR point features of each LiDAR point may be augmented with the corresponding encoded voxel, in the current voxel grid, of the voxel having the LiDAR point to obtain a revised feature set. For example, the augmenting may be to concatenate the second set of features with the features of the encoded voxel containing the LiDAR point to generate the revised LiDAR point features. The revised LiDAR point features may then be processed through another set of neural network layers to generate further revised features for each LiDAR point.

In Block 416, the LiDAR point features are augmented with decoded LiDAR voxel memory features to obtain augmented LiDAR point features. For each LiDAR point, the memory voxel in the LiDAR voxel memory that has the LiDAR point is identified. The revised features for the LiDAR point are augmented, such as through concatenation, with the decoded features of the memory voxel. The result is an augmented set of LiDAR point features for each LiDAR point. Because the augmented set of LiDAR point features include features from the LiDAR voxel memory (i.e., generated from previous LiDAR sweeps), the augmented set of features reflects not only the current LiDAR point cloud, but also past LiDAR sweeps.

In Block 418, the LiDAR points in the LiDAR point cloud are segmented using augmented LiDAR point features to obtain a segmented LiDAR point cloud. The segmenting processes the augmented set of features through a classifier for each LiDAR point. In one or more embodiments, the classifier processes the augmented set of features through another set of neural network layers. The classifier generates a probability for each class for each LiDAR point. The class with the highest probability may be estimated to be the type of object that the light beam reflected off of to generate the LiDAR point. In one or more embodiments, the output is the class for each LiDAR point to form a segmented LiDAR point cloud. The segmented LiDAR point cloud may be used by the virtual driver to predict the locations and movements of objects in the sensing region. The virtual driver may then trigger the actuators of the autonomous system to move accordingly.

FIG. 5 shows a flowchart for revising the LiDAR voxel memory. In Block 502, the LiDAR memory voxels are transformed in position to obtain transformed memory voxels. The transformation accommodates the changing reference frame of the LiDAR sensor as the autonomous system moves through the geographic region. Pose information from a separate component of the autonomous system may be used to determine the direction and amount of movement. Based on the direction and amount of movement, individual memory voxels are moved to a new location in the LiDAR memory voxel. Filtering may be performed to remove memory voxels that are outside of the geographic region within the range of the LiDAR sensor. Thus, memory voxels that are no longer relevant may be removed from memory in order to save space.

In Block 504, the LiDAR memory voxels are padded with the encoded voxels to obtain padded memory voxels. After translation, two 3D grids of voxels exist in one or more embodiments. The first 3D grid of voxels is the transformed memory voxels that are moved based on the movement of the autonomous system. The transformed memory voxels are part of the transformed LiDAR voxel memory reflecting past captures of the geographic region. The second 3D grid of voxels is the current voxel grid that reflects the current LiDAR point cloud. The current voxel grid has the encoded voxels. The two 3D grids have different densities. Namely, some of the memory voxels may be missing from the current voxel grid and some of the encoded voxels may be missing from the transformed LiDAR voxel memory.

To address the different densities, any missing memory voxel that is missing from the encoded voxels is added to the encoded voxels in the current voxel grid. The features of the newly added encoded voxel may be a weighted aggregation of the features of the neighboring voxels. The weights may be a function of the normalized distance between the newly added encoded voxel to the respective neighboring voxel. The result is an initial encoding for the newly added encoded voxel.

Similarly, any missing encoded voxel that is missing from the memory voxels is added to the memory voxels in the transformed LiDAR voxel memory. The features of the newly added memory voxel may be generated by performing a weighted aggregation of the features of the neighboring voxels. The weights may be a function of the normalized distance between the newly added memory voxel to the respective neighboring voxel. The result is an initial encoding for the newly added memory voxel.

In Block 506, an encoding of the padded memory voxels is refined to generate the revised LiDAR voxel memory. Through a neural network, the encoded voxels and the transformed memory voxels are processed using the initial embedding of the missing encoded voxel and the initial embedding of the missing transformed memory voxel to generate the revised LiDAR voxel memory. The memory refinement process gives a greater weight to the features learned from the current voxel grid. The result of the memory refinement process is an updated LiDAR voxel memory that may be stored.

Although FIGS. 4 and 5 show a processing from a single LiDAR sensor, different techniques may be used when multiple LiDAR sensors are on the autonomous system. For example, each LiDAR sensor of the multiple LiDAR sensors may be processed individually with corresponding individual LiDAR voxel memories. As another example, a single LiDAR voxel memory may be shared amongst multiple LiDAR sensors to individually segment the multiple LiDAR point clouds from the multiple LiDAR sensors. To use the single LiDAR voxel memory, the individual LiDAR point clouds may be transformed to a common frame of reference based on the locations of LiDAR sensors to each other. The LiDAR voxel memory may also be in the common frame of reference. As another example, the LiDAR point clouds from the multiple LiDAR sensors may be transformed to the common frame of reference and combined into a common LiDAR point cloud. The common LiDAR point cloud may be processed using the technique described in FIGS. 4 and 5 to segment the common LiDAR point cloud.

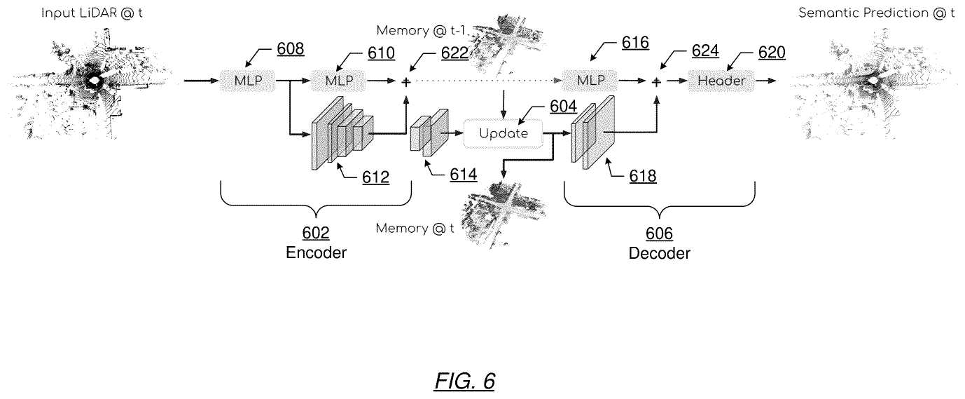

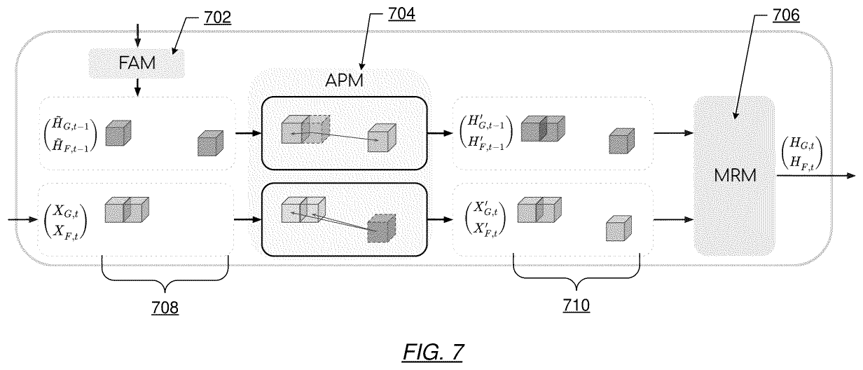

FIG. 6 and FIG. 7 and the discussion below are example implementations to perform the above embodiments. The example is for explanatory purposes and is not intended to limit the scope of the invention. FIG. 6 shows an example of a point segmentation system in accordance with one or more embodiments of the invention. In the following example, [symbol] ={ [symbol] }ₜ₌₁^{L} is a sequence of LIDAR point clouds, where L∈N⁺ is the sequence length and t∈[1,L] is the time index. Each LiDAR sweep Pₜ=(Gₜ, Fₜ) may be a 360° scan of the surroundings with Nₜ unordered LiDAR points. Gₜ∈R^{Nt×3} includes the Cartesian coordinates in the frame of the autonomous system and Fₜ∈R^{Nt} is the LiDAR intensity of the point. Tₜ₋₁→t∈SE(3) is the pose transformation from the frame of the autonomous system at time t−1 to t.

To make informed semantic predictions, the LiDAR voxel memory is maintained in three dimensions. The LiDAR voxel memory is sparse in nature since the majority of the 3D space is generally unoccupied. To represent the sparsity, the LiDAR voxel memory at time t using a sparse set of voxels containing the coordinates H_{G,t}∈R^{Mt×3} and the voxels corresponding learned embeddings H_{F,t}∈R^{Mt×dm}. Mₜ is the number of voxel entries in the latent memory at time t and dₘ is the embedding dimension. Preserving the voxel coordinates is used for alignment as the reference frame changes when the autonomous system moves. The voxel-based sparse representation provides computational benefits with respect to dense tensors as well as sparse representations at the point level without sacrificing performance.

Turning to FIG. 6, an inference may follow a three-step process that is repeated when a new LiDAR point cloud is obtained. The encoder (602) takes in the most recent LiDAR point cloud at current time t and extracts point-level and voxel-level observation embeddings. Further, the LiDAR voxel memory is updated (604) taking into account the voxel-level embeddings from the new observations. Additionally, the semantic predictions are decoded (606) by combining the point-level embeddings from the encoder and voxel-level embeddings from the updated LiDAR voxel memory.

The encoder (602) may include the LiDAR point level pipeline (i.e., pipeline on top) that computes point-level embeddings preserving the fine details and a voxel level pipeline (i.e., pipeline on bottom) that performs contextual reasoning through 3D sparse convolutional blocks. The LiDAR point level pipeline may obtain, as input, a seven-dimensional feature vector per LiDAR point. The seven-dimensional feature vector may be the x,y,z coordinates defined relative to the whole scanned area, intensity, and the x,y,z, relative offsets to the nearest voxel center as features. The encoder may include two shared multilayer perceptron models (MLPs) (608, 610) that output point embeddings. The LiDAR point embeddings, for LiDAR points matching the same voxel, and that are generated the first shared MLP (608), may be averaged over voxels of size v_{b} to obtain voxel features. The voxel features may then be processed through four residual blocks with 3D sparse convolutions (612). Each of the four residual blocks may down sample the feature map. Two additional residual blocks (614) with 3D sparse convolutions may be applied to up sample the sparse feature maps. Up sampling to one fourth of the original size may be performed for computational efficiency reasons to generate coarser features. The coarser features may be used to update the LiDAR voxel memory before decoding finer details to output the semantic predictions.

FIG. 7 shows an example of the memory refinement process to refine the LiDAR voxel memory. The memory refinement addresses challenges due to the changing reference frame as the autonomous system moves, different sparsity levels of the LiDAR voxel memory and current LiDAR point cloud, and the motion of other objects. The voxel position transformer (e.g., Feature Alignment Module (FAM) (702) in FIG. 7) may be used to align the previous memory state with the current observation embeddings. Subsequently, an adaptive padding process (e.g., Adaptive Padding Module (APM) (704) in FIG. 7) may be used to fill in missing observations in the current data and add new observations to the LiDAR voxel memory. Then, the memory refinement process (e.g., Memory Refinement Module (MRM) (706) in FIG. 7) may update the LiDAR voxel memory using padded observations. The LiDAR voxel memory is initialized using the first set of observations (i.e., the first LiDAR point cloud).

With respect to the FAM (702), the reference frame changes as the autonomous system moves. The FAM (702) transforms the LiDAR voxel memory from the reference frame at the previous timestep t−1 to the current timestep to align the reference frame with current observation embeddings. Memory voxel coordinates H_{G,t-1} use the pose information from Tₜ₋₁ to t in order to project from the previous reference to the current reference frame. Re-voxelizing may then be performed using the projected coordinates with a voxel size of vₘ. If multiple LiDAR points are inside the same memory voxel, the average of the multiple LiDAR points is the voxel feature. The resulting warped coordinates and embeddings of the memory in the reference frame at time t are denoted as Ĥ_{G,t} and Ĥ_{F,t}, respectively.

Turning to the APM (704), to handle the different sparsity or density levels of the latent memory and the voxel-level observation embeddings, the encoder features may be re-voxelized with the same voxel size vₘ, where LiDAR points within the same voxel are averaged. The resulting coordinates and embeddings are denoted as X_{G,t} and X_{F,t} in FIG. 7. The t is omitted in this section for brevity. Let x_{G} ⊆X_{G} and X_{F} ⊆X_{F} be the coordinates and embeddings of the new observations at time t that are not present in the memory. To obtain an initial guess of the memory embedding for a new entry, a weighted aggregation approach within the new observations' surrounding neighborhood. The weighted aggregation involves taking into account the coordinate offsets relative to the existing neighboring voxels in the LiDAR voxel memory. Additionally, the feature similarities and feature distances may be accounted for as additional cues for the aggregation process. Encoding feature similarities is useful for assigning weights to the neighborhood. In a dynamic scene with moving objects, the closest voxel may not always be the most important voxel. By providing feature similarities, the network can make more informed decisions. The goal of such completion is to make a hypothesis of the embedding at the previously unobserved location using the available information. Voxels are added in the memory where the coordinates are h′_{G}=x_{G} and the embedding of each voxel j is initialized with the following equations:

$${h}_{F , j}^{′} = {\sum }_{i ∈ {Ω}_{\hat{H}} ( j )} {w}_{ji} {\hat{H}}_{F , i} \qquad ( 1 )$$

$${w}_{ji} = ψ ( {\hat{H}}_{G , i} - {x}_{G , j} , ‖ {\hat{H}}_{F , i} - {x}_{F , j} ‖ , \frac{{\hat{H}}_{F , i} \cdot {x}_{F , j}}{‖ {\hat{H}}_{F , i} ‖ ‖ {x}_{F , j} ‖} ) \qquad ( 2 )$$

In the above equations, i and j are voxel indices, Ω_{Ĥ}(j) is the k-nearest neighborhood of voxel j in Ĥ_{G}, and ψ is a shared MLP followed by a softmax layer on the dimension of the neighborhood to ensure that the sum of the weights is equal to 1.

Further, the regions in the LiDAR voxel memory that are unseen in the current observation are identified. and denote their coordinates and embeddings as ĥ_{G} ⊆Ĥ_{G} and ĥ_{F} ⊆Ĥ_{F}. x′_{G} and x′_{F} are added to complete the current observation in a similar manner as described above.

In the example of FIG. 7, the APM transforms the current observations and LiDAR voxel memory from the example (708) to example (710). As shown in the example, the same voxels are in both the LiDAR voxel memory and the current voxel grid after the APM.

Turning to the MRM (706), the memory refinement may update the LiDAR voxel memory H′_{F,t-1} using the current padded observation embeddings X′_{F,t} using the following equations.

$${r}_{t} = sigmoid [ {Ψ}_{r} ( {X}_{F , t}^{′} , {H}_{F , t - 1}^{′} ) ] \\ {z}_{t} = sigmoid [ {Ψ}_{z} ( {X}_{F , t}^{′} , {H}_{F , t - 1}^{′} ) ] \\ {\hat{H}}_{F , t} = tanh [ {Ψ}_{u} ( {X}_{F , t}^{′} , {r}_{t} \cdot {H}_{F , t - 1}^{′} ) ] \\ {H}_{F , t} = {\hat{H}}_{F , t} \cdot {z}_{t} + {H}_{F , t - 1}^{′} \cdot ( 1 - {z}_{t} ) \qquad ( 3 )$$

In Equations (3), Ψr, Ψz, and Ψu are sparse 3D convolutional blocks with down sampling layers that aim to expand the receptive field and up sampling layers that restore the embeddings to the embedding's original size. Further, in equation (3), rₜ and zₜ are learned signals to reset or update the LiDAR voxel memory, respectively.

Returning to FIG. 6, the decoder (606) may include an MLP (616), two residual blocks with sparse 3D convolutions (618), and a linear semantic header (620). The LiDAR voxel memory embeddings (612) at coordinates Gₜ is added (622) with the point embeddings from the encoder (616). The resulting combined embeddings may then be voxelized with a voxel size of one fourth of v_{b} and further processed by two residual blocks (618) that up sample the feature maps back to the original resolution. In parallel, an MLP (616) takes the point embeddings before voxelization to retain the fine-grained details. Finally, the semantic header (620) takes the combination (624) of voxel and point embeddings to obtain per LiDAR point semantic predictions. The predictions are the probabilities of the different types of objects.

Training of the models may be used by backpropagating the loss. Loss may be a linear combination of segmentation loss functions and a point-wise regularizer to better supervise the network training as shown in Equation (4).

$$J = {β}_{wce} {J}_{wce} + {β}_{ls} {J}_{ls} + {β}_{reg} {J}_{reg} \qquad ( 4 )$$

In equation (4), J_{wce} denotes cross-entropy loss, weighted by the inverse frequency of classes, to address class imbalance in the dataset. Lovasz Softmax Loss (Jls) may be used to train the network, as Jls is a differentiable surrogate for the non-convex intersection over union (IoU) metric. Additionally, J_{reg} corresponds to the proposed pointwise regularizer. β_{reg}, β_{wce} and βₗₛ are hyperparameters.

The smoothness revision process may be used after performing the semantic predictions. The regularizer is designed to limit significant variations in semantic predictions within the 3D neighborhood of each LiDAR point, except when these variations occur at the class boundary. The smoothness may be calculated using the following.

$${J}_{reg} = \frac{1}{{N}_{t}} {\sum }_{i = 1}^{{N}_{t}} \vert Δ ( Y , i ) - Δ ( \hat{Y} , i ) \vert \\ Δ ( Y , i ) = \vert \frac{1}{\vert {Ω}_{{P}_{t}} ( i ) \vert} {\sum }_{j ∈ {Ω}_{{P}_{t}} ( i )} \vert {y}_{i} - {y}_{j} \vert \vert \qquad ( 5 )$$

In equation (5), Δ(Y,i) represents the ground truth semantic variation around point i, while Δ(Ŷ,i) corresponds to the predicted semantic variation around LiDAR point i. Ý∈R^{Nt×C} denotes the predicted semantic distribution over C classes, and Y∈R^{Nt×C} denotes the ground truth semantic one hot label. The variable yᵢ represents the i^{th} element of Y. Ω_{Pt}(i) denotes the neighborhood of point i in Pₜ, and |Ω_{Pt}(i)| represents the number of points in the neighborhood.

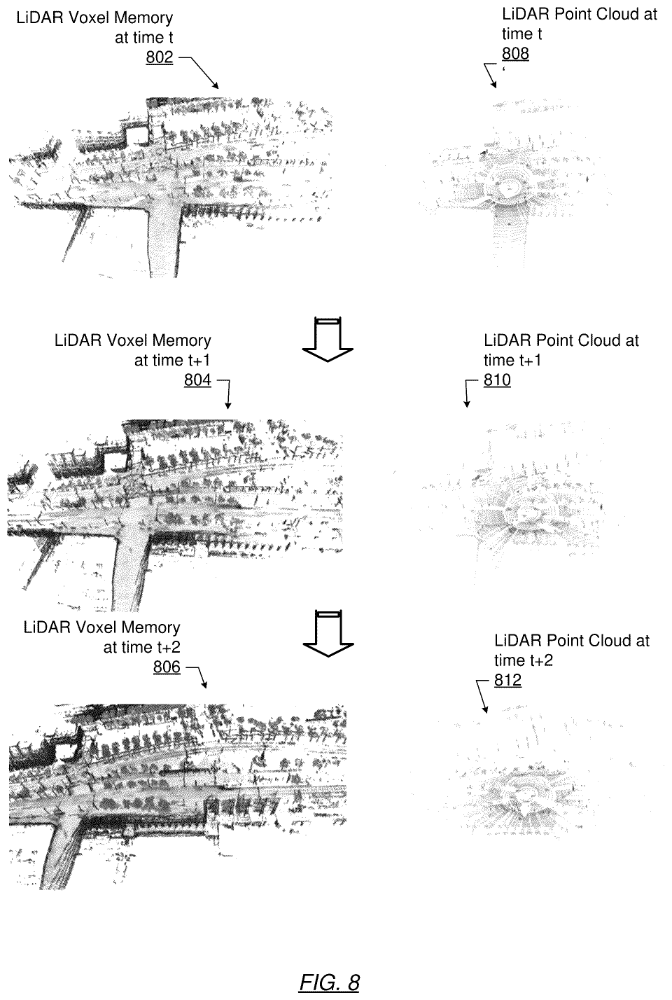

One or more embodiments are used by a virtual driver of an autonomous system to make predictions of surrounding areas. Because the autonomous system is moving, the predictions need to be performed in real time so in order to avoid accidents. FIG. 8 shows how the LiDAR voxel memory can supplement and provide more information for predicting the types of objects. In the example, the autonomous system is a self driving vehicle that is moving on roads. As with other real-world applications, the autonomous system needs to react quickly to any movement of objects. For example, a vehicle moving thirty to fifty miles an hour on a roadway. FIG. 8 shows the LiDAR voxel memory at time t (802), at time t+1 (804), and at time t+2 (806) along with the corresponding LiDAR point cloud at time t (808), at time t+1 (810), and at time t+2 (812). As shown in FIG. 8, with each successive LiDAR point cloud, the LiDAR voxel memory retains more and more information. The LiDAR voxel memory then is used to segment the LiDAR point cloud. Thus, even though the LiDAR point cloud at time t+2 (812) is sparse, using the LiDAR voxel memory at time t+2 (806) means that accurate detections may be performed.

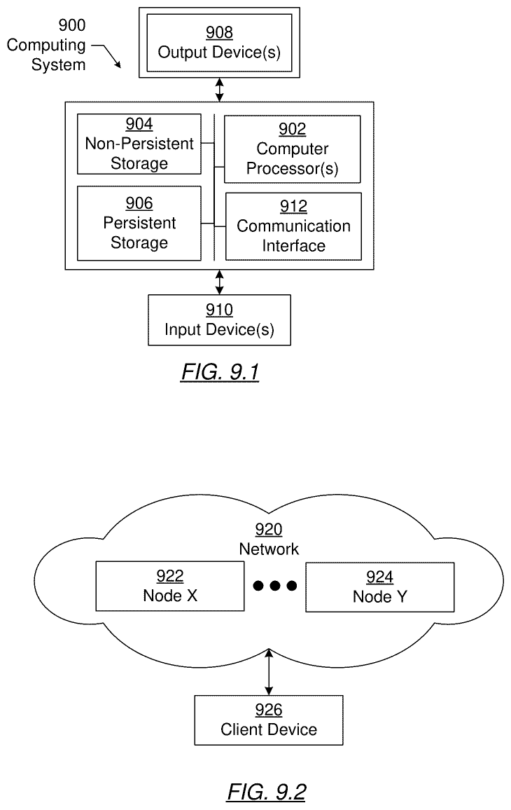

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 9.1, the computing system (900) may include one or more computer processors (902), non-persistent storage (904), persistent storage (906), a communication interface (912) (e.g., Bluetooth interface, infrared interface, network interface, optical interface, etc.), and numerous other elements and functionalities that implement the features and elements of the disclosure. The computer processor(s) (902) may be an integrated circuit for processing instructions. The computer processor(s) may be one or more cores or micro-cores of a processor. The computer processor(s) (902) includes one or more processors. The one or more processors may include a central processing unit (CPU), a graphics processing unit (GPU), a tensor processing unit (TPU), combinations thereof, etc.

The input devices (910) may include a touchscreen, keyboard, mouse, microphone, touchpad, electronic pen, or any other type of input device. The input devices (910) may receive inputs from a user that are responsive to data and messages presented by the output devices (908). The inputs may include text input, audio input, video input, etc., which may be processed and transmitted by the computing system (900) in accordance with the disclosure. The communication interface (912) may include an integrated circuit for connecting the computing system (900) to a network (not shown) (e.g., a local area network (LAN), a wide area network (WAN) such as the Internet, mobile network, or any other type of network) and/or to another device, such as another computing device.

Further, the output devices (908) may include a display device, a printer, external storage, or any other output device. One or more of the output devices may be the same or different from the input device(s). The input and output device(s) may be locally or remotely connected to the computer processor(s) (902). Many different types of computing systems exist, and the aforementioned input and output device(s) may take other forms. The output devices (908) may display data and messages that are transmitted and received by the computing system (900). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (900) in FIG. 9.1 may be connected to or be a part of a network. For example, as shown in FIG. 9.2, the network (920) may include multiple nodes (e.g., node X (922), node Y (924)). Each node may correspond to a computing system, such as the computing system shown in FIG. 9.1, or a group of nodes combined may correspond to the computing system shown in FIG. 9.1. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (900) may be located at a remote location and connected to the other elements over a network.

The nodes (e.g., node X (922), node Y (924)) in the network (920) may be configured to provide services for a client device (926), including receiving requests and transmitting responses to the client device (926). For example, the nodes may be part of a cloud computing system. The client device (926) may be a computing system, such as the computing system shown in FIG. 9.1. Further, the client device (926) may include and/or perform all or a portion of one or more embodiments.

The computing system of FIG. 9.1 may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
obtaining a LiDAR point cloud comprising a plurality of LiDAR points from a LiDAR sensor;
voxelizing the plurality of LiDAR points to obtain a plurality of LiDAR voxels;
encoding the plurality of LiDAR voxels to obtain a plurality of encoded voxels;
revising a LiDAR voxel memory using the plurality of encoded voxels to obtain revised LiDAR voxel memory;
decoding the revised LiDAR voxel memory to obtain a plurality of decoded LiDAR voxel memory features; and
segmenting the plurality of LiDAR points using the plurality of decoded LiDAR voxel memory features to generate a segmented LiDAR point cloud.

2. The method of claim 1, further comprising:
generating a plurality of LiDAR point features for the plurality of LiDAR points; and
augmenting the plurality of LiDAR point features with the plurality of decoded LiDAR voxel memory features to obtain a plurality of augmented LiDAR point features,
wherein segmenting the plurality of LiDAR points using the plurality of decoded LiDAR voxel memory features uses the plurality of augmented LiDAR point features generated from the plurality of decoded LiDAR voxel memory features.

3. The method of claim 1, further comprising:
processing, by a first set of neural network layers, the plurality of LiDAR points to obtain a first plurality of LiDAR point features;
processing, by a second set of neural network layers, the first plurality of LiDAR point features to obtain a second plurality of LiDAR point features;
augmenting the second plurality of LiDAR point features with the plurality of encoded voxels to obtain a third plurality of LiDAR point features; and
processing, by a third set of neural network layers, the third plurality of LiDAR point features to obtain a fourth plurality of LiDAR point features.

4. The method of claim 3, further comprising:
augmenting the fourth plurality of LiDAR point features with the plurality of decoded voxel memory features to obtain a plurality of augmented LiDAR point features,
wherein segmenting the plurality of LiDAR points using the plurality of decoded LiDAR voxel memory features uses the plurality of augmented LiDAR point features generated from the plurality of decoded LiDAR voxel memory features.

5. The method of claim 1, wherein encoding the plurality of LiDAR voxels comprises:
processing the plurality of LiDAR voxels through a convolutional neural network.

6. The method of claim 1, further comprising:
obtaining a plurality of LiDAR memory voxels from the LiDAR voxel memory;
transforming, in position, the plurality of LiDAR memory voxels to obtain a plurality of transformed memory voxels;
padding the plurality of LiDAR memory voxels with the plurality of encoded voxels to obtain a plurality of padded memory voxels; and
refining an encoding of the plurality of padded memory voxels to generate the revised LiDAR voxel memory.

7. The method of claim 6, further comprising:
adding a missing encoded voxel in the plurality of encoded voxels that is missing from the plurality of transformed memory voxels to the plurality of transformed memory voxels; and
performing a weighted aggregation of features of a first set of neighboring voxels of the plurality of transformed memory voxels, wherein the first set of neighboring voxels is adjacent to the missing encoded voxel to generate an initial embedding of the missing encoded voxel.

8. The method of claim 7, further comprising:
adding a missing memory voxel in the plurality of transformed memory voxels that is missing from the plurality of encoded voxels to the plurality of encoded voxels; and
performing a weighted aggregation of features of a second set of neighboring voxels of the plurality of encoded voxels, wherein the second set of neighboring voxels is adjacent to the missing memory voxel to generate an initial embedding of the missing transformed memory voxel.

9. The method of claim 8, further comprising:
processing, through a neural network, the plurality of encoded voxels and the plurality of transformed memory voxels using the initial embedding of the missing encoded voxel and the initial embedding of the missing transformed memory voxel to generate the revised LiDAR voxel memory.

10. The method of claim 6, further comprising:
filtering the plurality of LiDAR memory voxels to a geographic region of the LiDAR point cloud.

11. The method of claim 1, further comprising:
segmenting a plurality of LiDAR point clouds from a plurality of LiDAR sensors using the LiDAR voxel memory.

12. A system comprising:
one or more computer processors; and
a non-transitory computer readable medium comprising computer readable program code for causing the one or more computer processors to perform operations comprising:
obtaining a LiDAR point cloud comprising a plurality of LiDAR points from a LiDAR sensor;
voxelizing the plurality of LiDAR points to obtain a plurality of LiDAR voxels;
encoding the plurality of LiDAR voxels to obtain a plurality of encoded voxels;
revising a LiDAR voxel memory using the plurality of encoded voxels to obtain revised LiDAR voxel memory;
decoding the revised LiDAR voxel memory to obtain a plurality of decoded LiDAR voxel memory features; and
segmenting the plurality of LiDAR points using the plurality of decoded LiDAR voxel memory features to generate a segmented LiDAR point cloud.

13. The system of claim 12, wherein the operations further comprise:
generating a plurality of LiDAR point features for the plurality of LiDAR points; and
augmenting the plurality of LiDAR point features with the plurality of decoded LiDAR voxel memory features to obtain a plurality of augmented LiDAR point features,
wherein segmenting the plurality of LiDAR points using the plurality of decoded LiDAR voxel memory features uses the plurality of augmented LiDAR point features generated from the plurality of decoded LiDAR voxel memory features.

14. The system of claim 12, wherein the operations further comprise:
processing, by a first set of neural network layers, the plurality of LiDAR points to obtain a first plurality of LiDAR point features;
processing, by a second set of neural network layers, the first plurality of LiDAR point features to obtain a second plurality of LiDAR point features;
augmenting the second plurality of LiDAR point features with the plurality of encoded voxels to obtain a third plurality of LiDAR point features; and
processing, by a third set of neural network layers, the third plurality of LiDAR point features to obtain a fourth plurality of LiDAR point features.

15. The system of claim 14, wherein the operations further comprise:
augmenting the fourth plurality of LiDAR point features with the plurality of decoded voxel memory features to obtain a plurality of augmented LiDAR point features,
wherein segmenting the plurality of LiDAR points using the plurality of decoded LiDAR voxel memory features uses the plurality of augmented LiDAR point features generated from the plurality of decoded LiDAR voxel memory features.

16. The system of claim 12, wherein encoding the plurality of LiDAR voxels comprises:
processing the plurality of LiDAR voxels through a convolutional neural network.

17. The system of claim 12, wherein the operations further comprise:
obtaining a plurality of LiDAR memory voxels from the LiDAR voxel memory;
transforming, in position, the plurality of LiDAR memory voxels to obtain a plurality of transformed memory voxels;
padding the plurality of LiDAR memory voxels with the plurality of encoded voxels to obtain a plurality of padded memory voxels; and
refining an encoding of the plurality of padded memory voxels to generate the revised LiDAR voxel memory.

18. The system of claim 17, wherein the operations further comprise:
adding a missing encoded voxel in the plurality of encoded voxels that is missing from the plurality of transformed memory voxels to the plurality of transformed memory voxels; and
performing a weighted aggregation of features of a first set of neighboring voxels of the plurality of transformed memory voxels, wherein the first set of neighboring voxels is adjacent to the missing encoded voxel to generate an initial embedding of the missing encoded voxel.

19. The system of claim 18, wherein the operations further comprise:
adding a missing memory voxel in the plurality of transformed memory voxels that is missing from the plurality of encoded voxels to the plurality of encoded voxels; and
performing a weighted aggregation of features of a second set of neighboring voxels of the plurality of encoded voxels, wherein the second set of neighboring voxels is adjacent to the missing memory voxel to generate an initial embedding of the missing transformed memory voxel.

20. A non-transitory computer readable medium comprising computer readable program code for causing a computer system to perform operations comprising:
obtaining a LiDAR point cloud comprising a plurality of LiDAR points from a LiDAR sensor;
voxelizing the plurality of LiDAR points to obtain a plurality of LiDAR voxels;
encoding the plurality of LiDAR voxels to obtain a plurality of encoded voxels;
revising a LiDAR voxel memory using the plurality of encoded voxels to obtain revised LiDAR voxel memory;
decoding the revised LiDAR voxel memory to obtain a plurality of decoded LiDAR voxel memory features; and
segmenting the plurality of LiDAR points using the plurality of decoded LiDAR voxel memory features to generate a segmented LiDAR point cloud.
